(19) United States
(12) Patent Application Publication
(10) Pub. No.: US 2004/0032702 A1
(43) Pub. Date: Feb. 19, 2004

(54) Adapter mechanism for use with a circuit breaker

(76) Inventors: Jeffery Gibson, Hookstown, PA (US); Craig A. Rodgers, Butler, PA (US)

Correspondence Address: Martin J. Moran, Cutler-Hammer, Technology & Quality Center, RIDC Park West, 170 Industry Drive, Pittsburgh, PA, 15275-1032, US

(21) Appl. No.: 10/222,698

(22) Filed: Aug. 16, 2002

(51) Int. Cl. H02H 3/00

(52) U.S. Cl. 361/102

(57) ABSTRACT

An adapter mechanism is configured to permit a previously known accessory device that had been configured to be used in conjunction with a previously known circuit breaker to be operatively connected with a different type of circuit breaker. The adapter mechanism includes a first interface that is engageable with a handle of the circuit breaker as well as a second interface that is engageable with a movable arm or a latch mechanism of the circuit breaker. The adapter mechanism further includes a support member upon which the first interface is rotatably disposed, with the support member being formed with a plurality of clips that permit the support member and thus the adapter mechanism to be removably mounted on the circuit breaker.

### BACKGROUND OF THE INVENTION

1. Field of the Invention

The present invention relates generally to circuit breakers and, more particularly, to an adapter mechanism for operatively connecting an accessory device with a circuit breaker.

2. Description of the Related Art

Numerous types of circuit breakers are known and understood in the relevant art. Among the purposes for which circuit breakers are provided is to interrupt an electrical circuit on command or according to certain criteria. For instance, a given circuit breaker may be configured to interrupt a circuit during one or more specified overload conditions or other conditions.

Most circuit breakers are configured to at least provide overcurrent protection, meaning that the circuit breaker will trip in the event that the current exceeds a certain threshold level according to certain specified criteria. It is often desirable, however, for a circuit breaker to possess additional capabilities or provide additional functions. For instance, it may be desirable for a circuit breaker to have an under-voltage protection system whereby the circuit breaker will trip if the voltage falls below a certain level. Alternatively, or in addition thereto, it may be desirable for a circuit breaker to include a shunt trip whereby the circuit breaker can be remotely tripped by an operator. Alternatively, or in addition thereto, it may be desirable for the circuit breaker to include an auxiliary switch function whereby a switch mimics the state of the contacts within the circuit breaker and operates lights or sends a signal to a programmable logic controller at any time the contacts are open. Still alternatively, or in addition thereto, the circuit breaker may include a bell alarm function which signals an audible alarm only when a tripping function has occurred within the circuit breaker.

One or more of these additional features may be appropriate for a circuit breaker in a given application. As a general matter, however, each such additional function is typically provided by componentry that is operatively connected with other components that are within the circuit breaker.

While it has been known to provide numerous such features internally within a given circuit breaker, it has also been known to provide circuit breakers solely with overcurrent protection capabilities internally therein and to provide auxiliary devices that are externally connectable with the circuit breaker to provide additional functions such as under-voltage protection, shunt trip capabilities, auxiliary switch functions and bell alarm functions to the circuit breaker. The latter type of system permits a given basic circuit breaker to be augmented with specific additional functions as needed.

Such auxiliary devices have, however, needed to be tailored to a specific type of circuit breaker and have been generally incapable of being used in conjunction with circuit breakers of different configurations. The development of separate lines of auxiliary devices for numerous different types of circuit breaker would be costly. It thus would be desirable to provide a mechanism whereby auxiliary devices that had been developed for use in conjunction with a first type of circuit breaker could be employed in conjunction with a second different type of circuit breaker.

### SUMMARY OF THE INVENTION

In view of the foregoing, an adapter mechanism is configured to permit a previously known accessory device that had been configured to be used in conjunction with a previously known circuit breaker to be operatively connected with a different type of circuit breaker. The adapter mechanism includes a first interface that is engageable with a handle of the circuit breaker as well as a second interface that is engageable with a movable arm or a latch mechanism of the circuit breaker. The adapter mechanism further includes a support member upon which the first interface is rotatably disposed, with the support member being formed with a plurality of clips that permit the support member and thus the adapter mechanism to be removably mounted on the circuit breaker.

An aspect of the present invention is to provide an adapter mechanism that permits an accessory device that had been configured for use in conjunction with a first type of circuit breaker to be used in conjunction with a second type of circuit breaker.

Another aspect of the present invention is to provide an adapter mechanism that can be mounted on a circuit breaker and that is capable of having an auxiliary device mounted thereon.

Another aspect of the present invention is to provide an adapter mechanism that transfers mechanical motion between a circuit breaker and an accessory device.

Accordingly, an aspect of the present invention is to provide an adapter mechanism for operatively connecting together a circuit breaker and an accessory device, the circuit breaker including a handle, a latch mechanism, and a movable arm, in which the general nature of the adapter mechanism can be stated as including a support member structured to be disposed between the circuit breaker and the accessory device, a first interface rotatably disposed on the support member and structured to be engaged with the handle of the circuit breaker, and a second interface that is movable with respect to the support member and is structured to be engageable with at least one of the latch mechanism and the movable arm of the circuit breaker.

The support member of such an adapter mechanism may include a mounting flange, with the first interface being rotatably mounted on the mounting flange. Additionally, the first interface may include at least a first spring-biased tab that retains the first interface on the mounting flange.

Another aspect of the present invention is to provide a combination that can be generally stated as including a circuit breaker, an accessory device, and an adapter mechanism interposed between and operatively connecting together the circuit breaker and the accessory device, the circuit breaker including a handle, a latch mechanism, and a movable arm, the adapter mechanism including a support member, a first interface, and a second interface, the first interface being rotatably disposed on the support member and being engaged with the handle of the circuit breaker, and the second interface being movable with respect to the support member and the circuit breaker and being engageable with at least one of the latch mechanism and the movable arm of the circuit breaker.

### BRIEF DESCRIPTION OF THE DRAWINGS

A further understanding of the invention can be gained from the following description of the preferred embodiment when read in conjunction with the accompanying drawings in which:

FIG. 1 is an exploded isometric view of an adapter mechanism in accordance with the present invention along with a circuit breaker and an accessory device;

FIG. 1A is another exploded isometric view of the adapter mechanism, circuit breaker, and accessory device;

FIG. 2 is an isometric view of the adapter mechanism operationally interposed between the circuit breaker and the auxiliary device;

FIG. 3 is a front elevational view of the interior of the circuit breaker and additionally showing a portion of an interface of the adapter mechanism disposed over the circuit breaker;

FIG. 4 is an isometric view of the adapter mechanism mounted on the circuit breaker;

FIG. 5 is an isometric view of a latch mechanism and a movable arm of the circuit breaker;

FIG. 6 is an enlarged view of a portion of FIG. 3;

FIG. 7 is an exploded isometric view of a support member and an interface of the adapter mechanism;

FIG. 8 is an enlarged isometric view of the interface of FIG. 7; and

FIG. 9 is an isometric exploded view of the interface of FIG. 7 disposed between a circuit breaker handle and an accessory device handle.

Similar numerals refer to similar parts throughout the specification.

### DESCRIPTION OF THE PREFERRED EMBODIMENT

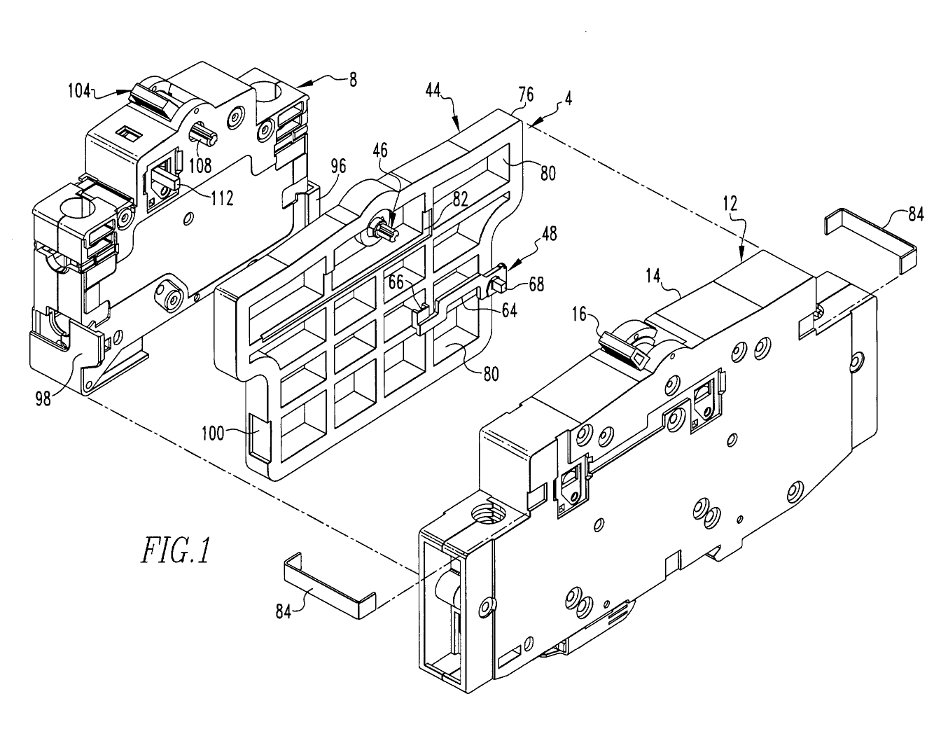

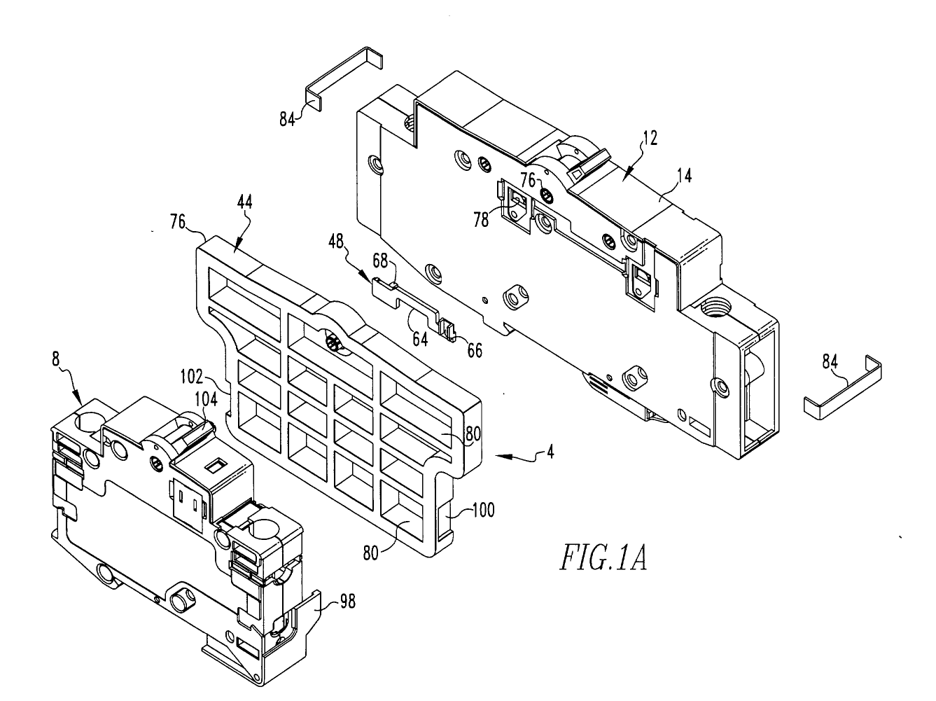

An adapter mechanism 4 in accordance with the present invention is indicated generally in FIGS. 1, 2, and 4. As is best shown in FIG. 2, the adapter mechanism 4 is advantageously configured to permit an accessory device 8 to be operatively connected with a circuit breaker 12. As is understood in the relevant art, the accessory device 8 may provide any of a wide variety of features and/or functions to the circuit breaker 12, including a remote trip or shunt trip capability, an under-voltage trip system, an auxiliary switch, and a bell alarm switch, among other such desirable functions. The accessory device 8 is also configured to be operatively connected with circuit breakers having configurations that are different than that of the circuit breaker 12.

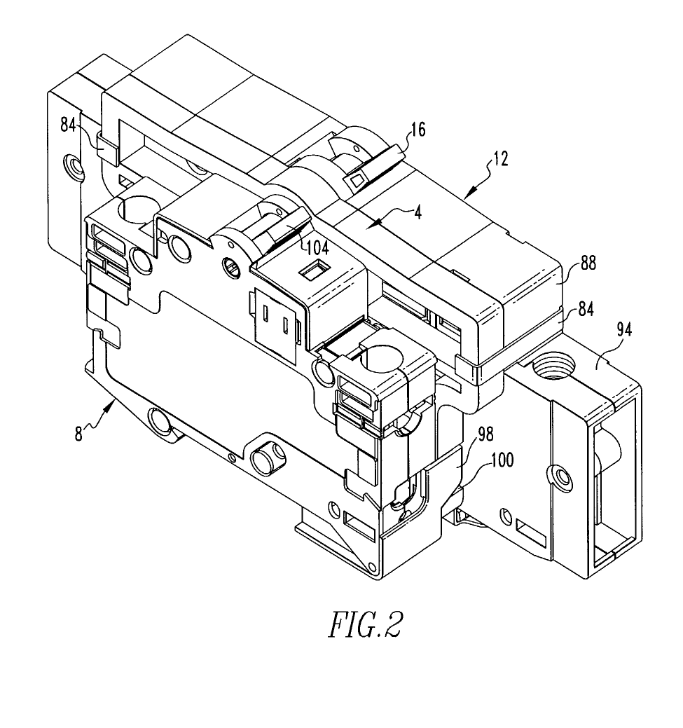

As is best shown in FIG. 3, the circuit breaker 12 includes a case 14 and, among other components, a circuit breaker handle 16, a latch mechanism 18, and a movable arm 20. The circuit breaker handle 16 is operatively connected with the latch mechanism 18 and the movable arm 20 in order to selectively engage and disengage at least a first set of electrical contacts 22 within the circuit breaker 12 in a known fashion.

The circuit breaker handle 16 is pivotably mounted on the case 14 and is formed with a handle socket 24 that is oriented coaxially with the pivot axis of the handle 16. As will be set forth more fully below, the handle socket 24 assists in permitting operative engagement of the accessory device 8 with the circuit breaker 12.

The movable arm 20 is pivotable about a pin 28 that is fixedly mounted to the case 14. In the event of a tripping condition, the movable arm 20 pivots about the pin 28 from an ON position (depicted generally in FIG. 3) in a counter-clockwise direction with respect to FIG. 3 to an OFF position (not shown), which separates the contacts 22 in a known fashion.

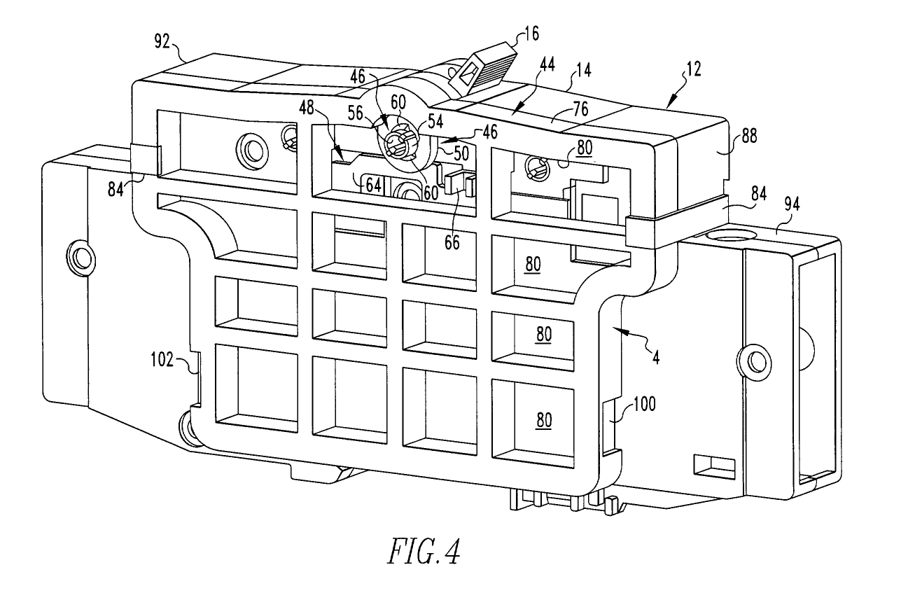

As is best shown in FIG. 5, the movable arm 20 includes a box member 30, a plate member 32 and a movable contact 34. The box member 30 and the plate member 32 are connected with one another and are together pivotably mounted on the pin 28. The movable contact 34 is mounted between the box member 30 and the plate member 32 and protrudes therefrom. It can be seen that the plate member 32 includes an outwardly extending flap 36 that is provided for purposes to be set forth more fully below.

It can further be seen from FIG. 5 that the latch mechanism 18 includes a latchpiece 38 and a spring 40. The latchpiece 38 is pivotably mounted on the pin 28. The spring 40 is a sear spring that extends about the pin 28. The latchpiece 38 includes a protrusion 42 that extends outwardly therefrom and is substantially parallel with and spaced from the flap 36. As is understood in the relevant art, if the circuit breaker 12 is in the ON position depicted generally in FIG. 3 and the latchpiece 38 is caused to pivot about the pin 28 in a counter-clockwise direction with respect to FIG. 3, the latch mechanism 18 will, in a known fashion, perform a tripping operation and thereby cause the movable arm 20 to pivot about the pin 28 in a counter-clockwise direction with respect to FIG. 3, thereby separating the contacts 22 and stopping the flow of current through the circuit breaker 12. Such pivoting of the latchpiece 38 with resultant pivoting of the movable arm 20 may result from engagement of a solenoid plunger 45 (FIG. 3) with the latchpiece 38 during an overcurrent condition.

While the circuit breaker 12 is configured to internally possess an overcurrent tripping function, it may be desirable to externally provide a remote tripping function and/or an under-voltage tripping function. Alternatively, or in addition thereto, it may desirable to provide an auxiliary switch function and/or an bell alarm function. Such functions are each incorporated into separate accessory devices 8, with the accessory devices 8 each being operatively connected with the circuit breaker 12. While only one such accessory device 8 is depicted herein, it is understood that multiple accessory devices 8 can be connected with one another or “ganged” to provide multiple accessory functions to the circuit breaker 12.

In order to operatively connect the accessory device 8 with the circuit breaker 12, the adapter mechanism 4 includes a support member 44, a first interface 46, and a second interface 48. The first interface 46 is rotatably mounted on the support member 44, and the second interface 48 is translatable with respect to the support member 44, although such a configuration is not strictly necessary in order to provide the advantageous aspects of the present invention.

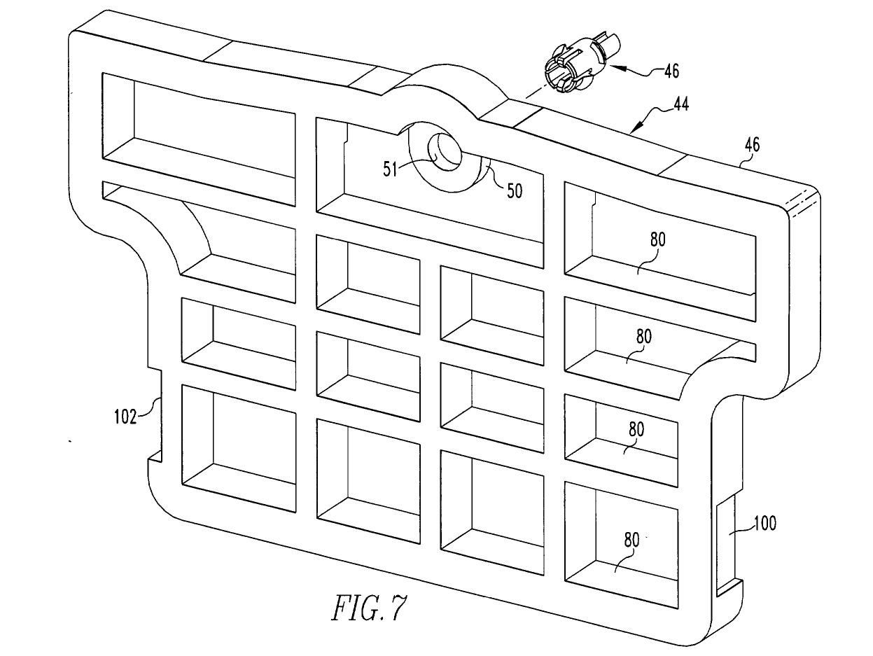

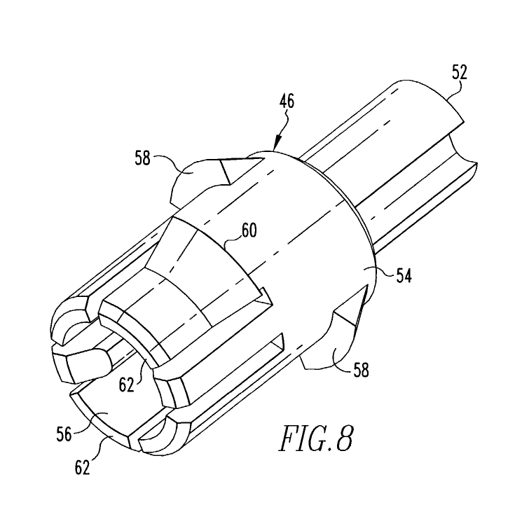

The support member 44 includes a support body 76 and a mounting flange 50. The support body 76 includes a recess 82 (FIG. 1A) in which the second interface 48 can translate with respect to the support member 44. The mounting flange 50 extends from the support body 76 and is formed with a hole 51 (FIG. 7) within which the first interface 46 is rotatably mounted. As can be seen in FIG. 8, the first interface 46 includes a barrel 54, a barrel projection 52, pair of movable tabs 60, and a pair of stationary tabs 58. The barrel 54 is a generally cylindrical member that is formed with a barrel socket 56. The barrel socket 54 and the barrel projection 52 are axially aligned.

The stationary tabs 58 are disposed at diametrically opposed positions on the barrel 54. Each movable tab 60 is disposed on a separate deflectable leg 62, whereby the movable tabs 60 are “movable” by virtue of the elastic deflection of the legs 62 upon the barrel 54 being slidingly inserted into the hole 51 of the mounting flange 50. The movable tabs 60 are thus biased by the legs 62 to the position shown in the accompanying figures.

More specifically, the movable tabs 60 are biased radially outwardly from the barrel 54 and are engageable against a first generally planar surface of the mounting flange 50. The stationary tabs 58 are similarly engageable against a second opposite generally planar surface of the mounting flange 50. The first interface 46 is thus rotatably retained within the hole 51 by interposing the mounting flange between the pairs of stationary tabs 58 and movable tabs 60. The movable tabs 60 can alternatively be outwardly biased by providing living hinges that extend between the movable tabs 60 and the barrel 54 or with the use of other structures such as springs and the like.

The second interface 48 includes a translation plate 64, a groove 66, and actuation peg 68. The actuation peg 68 is fixedly mounted on the translation plate 64 and is disposed generally opposite the groove 66. The actuation peg 68 is an elongated member having a generally rectangular cross-section and extending generally perpendicularly outwardly from the translation plate 64. As will be set forth more fully below, the actuation peg 68 is engageable with either or both of the latch mechanism 18 and the movable arm 20. As will also be set forth more fully below, the groove 66 is configured to receive a component of the accessory device 8 therein.

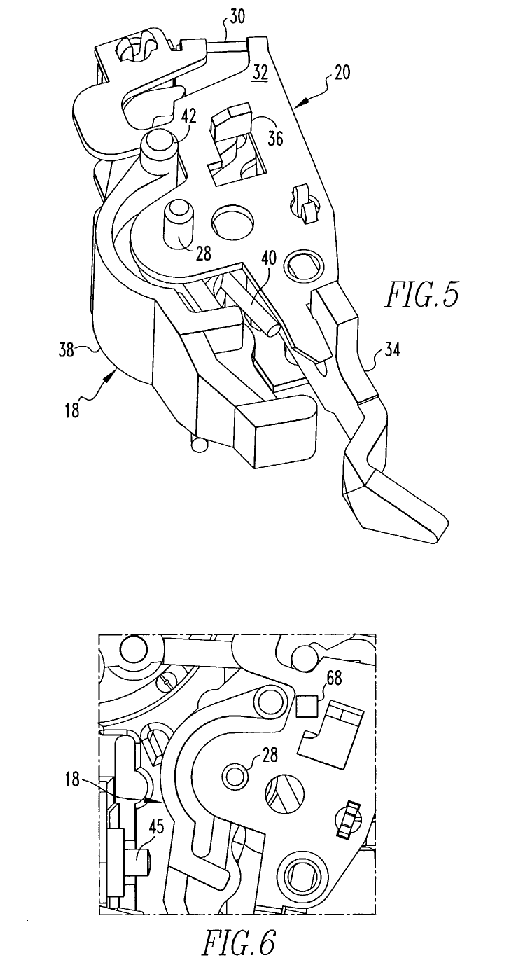

The actuation peg 68 is indicated in FIGS. 3 and 6 as being disposed generally between the flap 36 and the protrusion 42. It can be seen that by translating the actuation peg 68 to the left from the perspective of FIG. 3 to engage and move the protrusion 42, the latchpiece 38 would be pivoted in a counterclockwise direction, which would trip the latch mechanism 18. Such tripping would pivot the latch mechanism 18 and the movable arm 20 about the pin 28 in a counterclockwise direction from the perspective of FIG. 3. It can further be seen that if the latch mechanism 18 is tripped by the solenoid plunger 45, or if the circuit breaker handle 16 is manually moved from the ON position of FIG. 3 to an OFF position (not specifically depicted herein), the counter-clockwise pivoting (from the perspective of FIG. 3) of the movable arm 20 would cause the flap 36 to engage the actuation peg 68 and translate it to the left. It thus can be seen that the second interface 48 generally mimics movement of the movable arm 20.

The support body 76 is formed with a plurality of voids 80 extending therethrough and a plurality of clips 84 that are separate from the support body 76 and that are extendable between the support body 76 and the circuit breaker 12. As is best shown in FIG. 3, the case 14 of the circuit breaker 12 includes a first surface 88 and a second surface 92 that are substantially parallel with one another, and it is understood that the first and second surfaces 88 and 92 are engaged by the clips 84. Such engagement of the aforementioned clips 84 with the first and second surfaces 88 and 92 resists movement of the support body 76 with respect to the circuit breaker 12 along a direction that can be defined generally as extending between the aforementioned clips 84. It can further be seen that when the two aforementioned clips 84 are engaged with the first and second surfaces 88 and 92, the clips are additionally each engaged against an upper surface 94 of the case 14.

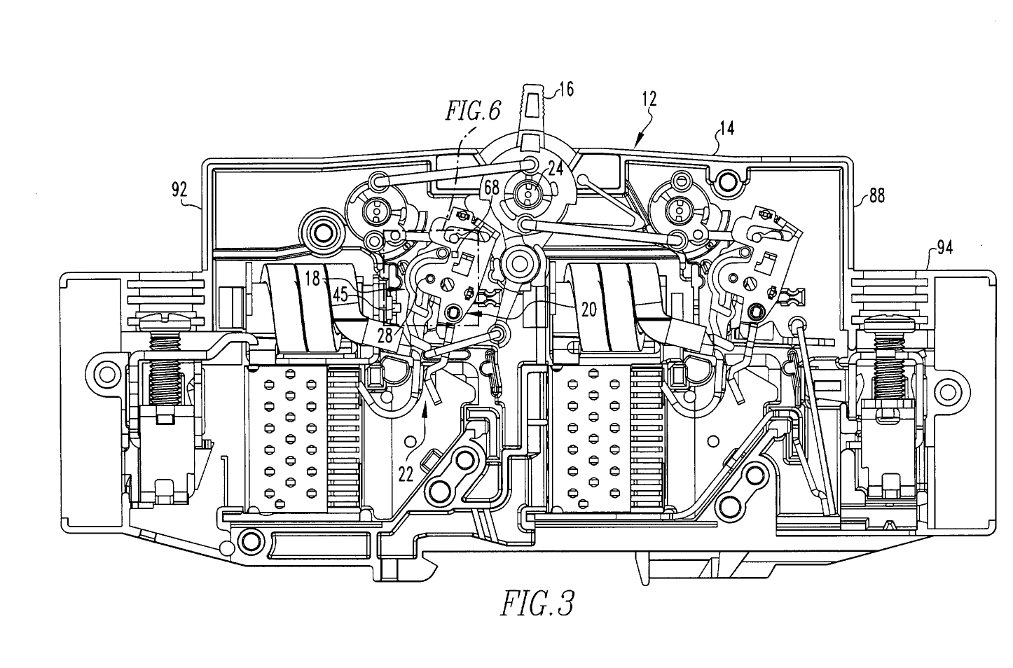

As can be seen in FIGS. 1 and 4, the support body 76 is formed with a pair of attachment ledges 100 and 102 that are configured to engageably receive a pair of mounting members 96 and 98 that extend from the accessory device 8 to permit the accessory device 8 to be mounted on the support body 76. The attachment ledges 100 and 102 are depicted in FIGS. 1 and 4 as being recessed into the support body 76 but may be of other configurations as appropriate.

In operation, the adapter mechanism 4 is mounted on the circuit breaker 12 by engaging the clips 84 with the case 14 as indicated above and as is depicted generally in FIG. 4. In so doing, the barrel projection 52 of the first interface 46 is engaged with the handle socket 24 of the circuit breaker handle 16, and the actuation peg 68 is received between the flap 36 of the movable arm 20 and the protrusion 42 of the latch mechanism 18. It can be seen from FIG. 1A that appropriate openings 74 and 78 are formed in the case 14 that permit access to the inner regions of the circuit breaker 12 by the barrel 54 and the actuation peg 68.

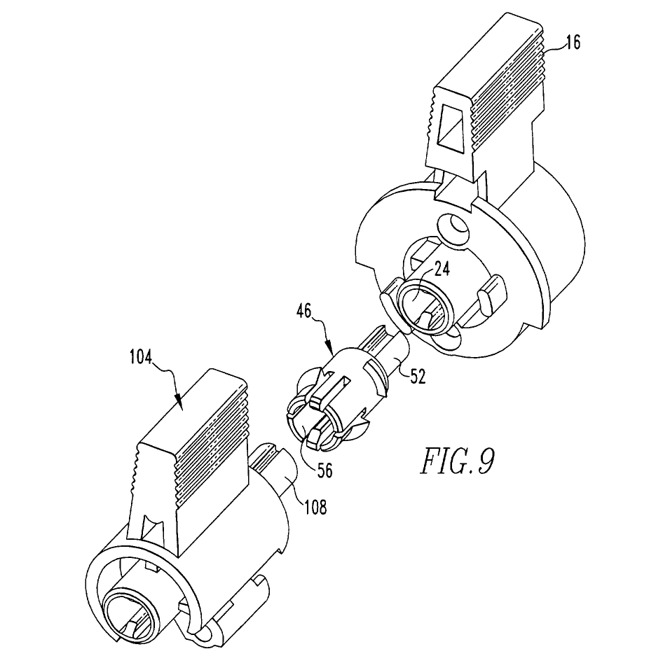

As is best understood from FIG. 1, the accessory device 8 includes an accessory handle 104 and an accessory actuator 112. The accessory handle 104 is pivotable with respect to the accessory device 8 and includes an accessory projection 108 that is receivable in the barrel socket 56 of the first interface 46 (FIG. 9). The accessory actuator 112 is receivable in the groove 66 of the second interface 48 and is translatable with respect to the accessory device 8.

The accessory device 8 can be mounted onto the support member 44 as is indicated generally in FIG. 2. In so doing, the accessory projection 108 is received in the barrel socket 56 (FIG. 9), the accessory actuator 112 is received in the groove 66, and the mounting members 96 and 98 (FIG. 1) of the accessory device 8 are engaged with the attachment ledges 100 and 102 formed in the support body 76.

For instance, if the accessory device 8 is intended to provide an additional tripping function, such as a shunt trip or an under-voltage trip, the accessory actuator 112 translates the second interface 48 to the left with respect to FIG. 3 to engage the protrusion 42 and to trip the circuit breaker 12 in a known fashion. In such a circumstance, the adapter mechanism 4 transfers mechanical motion from the accessory device 8 to the circuit breaker 12.

If the accessory device is intended to provide an auxiliary switch or a bell alarm function, when the circuit breaker 12 becomes tripped, the movable arm 20 pivots in a counter-clockwise direction with respect to FIG. 3, and the flap 36 will engage the actuation peg 68 and thus translate the second interface 48 to the left with respect to FIG. 3. The second interface 48 will thereby transmit such pivoting motion of the movable arm 20 into linear motion which translates the accessory adapter 112. In such a situation, therefore, the adapter mechanism 4 transmits mechanical motion from the circuit breaker 12 to the accessory device 8.

It is understood that the handle 16 of the circuit breaker 12 is movable between the ON position (depicted generally in FIG. 3), the OFF position, and a TRIPPED position (not specifically depicted herein). By receiving the barrel projection 52 of the first interface 46 in the handle socket 24 (FIG. 9), the specific rotational position of the handle 16 is transmitted via the first interface 46 to the accessory projection 108 and thus to the accessory handle 104. In such a circumstance the adapter mechanism 4 transfers mechanical motion from the circuit breaker 12 to the accessory device 8.

If the accessory device 8 provides a bell alarm function, the accessory device 8 will rely upon the movements of both the first and second interfaces 52 and 66 to determine whether or not a tripping function has occurred by detecting the time lag in motion between pivoting of the movable arm 20 and subsequent pivoting of the handle 16. If the accessory device 8 provides a remote trip, an under-voltage trip, or an auxiliary switch function, such functions will generally rely solely upon mechanical communication between the circuit breaker 12 and the accessory device 8 via the second interface 48.

Regardless of the specific nature of the accessory device 8, the accessory device 8 can additionally transmit motion to additional accessory devices (not shown) that can be mounted onto the accessory device 8 and that provide additional functions to the circuit breaker 12 other than that provided by the accessory device 8. As is generally understood in the relevant art, a maximum of three accessory devices can be successfully connected with the circuit breaker 12, although other numbers may be appropriate depending upon the specific configuration of the accessory devices. The mounting of excess accessory devices may result in unreliable performance due to lost motion.

In accordance with the foregoing, therefore, the adapter mechanism 4 advantageously transmits mechanical motion back and forth between the circuit breaker 12 and the accessory device 8. The adapter mechanism 4 additionally permits the accessory device 8, which had previously been configured to cooperate with a circuit breaker having a different configuration than the circuit breaker 12, to cooperate operatively with the circuit breaker 12.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. An adapter mechanism for operatively connecting together a circuit breaker and an accessory device, the circuit breaker including a handle, a latch mechanism, and a movable arm, the adapter mechanism comprising:
a support member structured to be disposed between the circuit breaker and the accessory device;
a first interface rotatably disposed on the support member and structured to be engaged with the handle of the circuit breaker; and
a second interface that is movable with respect to the support member and is structured to be engageable with at least one of the latch mechanism and the movable arm of the circuit breaker.

2. The adapter mechanism as set forth in claim 1, in which the support member includes at least a first clip that is structured to engage one of the circuit breaker and the accessory device to mount together the support member and the one of the circuit breaker and the accessory device.

3. The adapter mechanism as set forth in claim 2,
in which the support member includes a second clip;
the at least first and second clips being structured to engage substantially parallel surfaces of the one of the circuit breaker and the accessory device and to resist movement of the support member with respect to the one of the circuit breaker and the accessory device along a first direction defined generally between the at least first and second clips.

4. The adapter mechanism as set forth in claim 1, in which the support member includes a mounting flange, the first interface being rotatably mounted on the mounting flange.

5. The adapter mechanism as set forth in claim 4, in which the first interface includes at least a first movable tab that retains the first interface on the mounting flange.

6. The adapter mechanism as set forth in claim 5,
in which the first interface includes at least a first stationary tab, the mounting flange being interposed between the at least first movable tab and the at least first stationary tab.

7. The adapter mechanism as set forth in claim 1, in which the support member is formed with at least a first attachment ledge;
the at least first attachment ledge being structured to receive a mounting member of the accessory device.

8. The adapter mechanism as set forth in claim 7, in which the at least first attachment ledge is recessed in the support member.

9. The adapter mechanism as set forth in claim 1,
in which the first interface includes a barrel socket;
the barrel socket being structured to receive an accessory projection of the accessory device;
the first interface including a barrel projection;
the barrel projection being structured to be received in a handle socket of the circuit breaker;
the barrel socket and the barrel projection being axially aligned.

10. The combination comprising:
a circuit breaker;
an accessory device; and
an adapter mechanism interposed between and operatively connecting together the circuit breaker and the accessory device;
the circuit breaker including a handle, a latch mechanism, and a movable arm;
the adapter mechanism including a support member, a first interface, and a second interface;
the first interface being rotatably disposed on the support member and being engaged with the handle of the circuit breaker; and
the second interface being movable with respect to the support member and the circuit breaker and being engageable with at least one of the latch mechanism and the movable arm of the circuit breaker.

11. The combination as set forth in claim 10, in which the support member includes at least a first clip that is engaged with one of the circuit breaker and the accessory device to mount together the support member and the one of the circuit breaker and the accessory device.

12. The combination as set forth in claim 11,
in which the support member includes a second clip;
the at least first and second clips being structured to engage substantially parallel surfaces of the one of the circuit breaker and the accessory device and to resist movement of the support member with respect to the one of the circuit breaker and the accessory device along a first direction defined generally between the at least first and second clips.

13. The combination as set forth in claim 10, in which the support member includes a mounting flange, the first interface being rotatably mounted on the mounting flange.

14. The combination as set forth in claim 13, in which the first interface includes at least a first movable tab that retains the first interface on the mounting flange.

15. The combination as set forth in claim 14,
in which the first interface includes at least a first stationary tab, the mounting flange being interposed between the at least first movable tab and the at least first stationary tab.

16. The combination as set forth in claim 10, in which the support member is formed with at least a first attachment ledge;
one of the circuit breaker and the accessory device including a mounting member;
the at least first attachment ledge being structured to receive the mounting member to mount the support member together with the one of the circuit breaker and the accessory device.

17. The combination as set forth in claim 16, in which the at least first attachment ledge is recessed in the support member.

18. The combination as set forth in claim 10,
in which the first interface includes a barrel socket;
the accessory device including an accessory projection;
the accessory projection being received in the barrel socket;
the first interface including a barrel projection;
the circuit breaker including a handle socket;
the barrel projection being received in the handle socket;
the barrel socket and the barrel projection being axially aligned.
